(19) United States
(12) Patent Application Publication
(10) Pub. No.: US 2011/0283294 A1
(43) Pub. Date: Nov. 17, 2011

(54) DETERMINING MULTI-PROGRAMMING LEVEL USING DIMINISHING-INTERVAL SEARCH

(76) Inventors: Janet L. WIENER, Palo Alto, CA (US); Lyle H. Ramshaw, Palo Alto, CA (US); Harumi Kuno, Cupertino, CA (US); William K. Wilkinson, Sunnyvale, CA (US); Stefan Krompass, Eching (DE)

(21) Appl. No.: 12/777,425

(22) Filed: May 11, 2010

(51) Int. Cl. G06F 9/46

(52) U.S. Cl. 718/107

(57) ABSTRACT

A method of determining a multiprogramming level (MPL) for a first computer subsystem may be implemented on a second computer subsystem. The method may include selecting an initial MPL interval having endpoints that bound a local extremum of a computer-system operation variable that is a unimodal function of the MPL. For each interval having a length more than a threshold, operation-variable values for two intermediate MPLs in the interval may be determined. The interval may be diminished by the section of the interval between the one of the intermediate MPLs having an operation-variable value further from the extremum, and the interval endpoint adjacent to the one intermediate MPL. The operating MPL may be set equal to the other intermediate MPL when the interval has a length that is not more than the threshold.

### BACKGROUND

A database is a collection of information. A relational database is a database that is perceived by its users as a collection of tables. Each table arranges items and attributes of the items in rows and columns respectively. Each table row corresponds to an item (also referred to as a record or tuple), and each table column corresponds to an attribute of the item (referred to as a field, an attribute type, or field type). To retrieve information from a database, the user of a database system constructs a query. A query contains one or more operations that specify information to retrieve from, manipulate, or update the database. The system scans tables in the database and processes the information retrieved from the tables to execute the query.

In complex database systems, queries or other transactions may execute in parallel or be programmed to execute concurrently. Additionally, there may be multiple types of queries that may be executed at a time. A multi-programming level (MPL) is a number of queries that are scheduled to be executed concurrently. Accordingly, finding a good MPL for a set of queries running on a database system may be difficult. If the MPL is too low, then response time and throughput may suffer. If the MPL is too high, then there may be excessive resource contention and response time and throughput may again suffer.

### BRIEF DESCRIPTION OF THE DRAWINGS

Features and advantages of examples of systems, methods and devices will become apparent by reference to the following detailed description and drawings.

FIG. 1 is a block diagram depicting an example of a computer system in accordance with an embodiment of the invention.

FIG. 2 is a flow chart of an example of a method of determining a multiprogramming level (MPL) for a first computer subsystem in accordance with an embodiment of the invention.

FIG. 3 is graph illustrating an example of throughput as a unimodal function of MPL.

FIG. 4 is a flow chart of another example of a method of determining a multiprogramming level (MPL) for a first computer subsystem in accordance with an embodiment of the invention.

FIG. 5 is a graphic illustration of an example of a sequence of steps performed in a method of determining a multiprogramming level (MPL) for a first computer subsystem in accordance with an embodiment of the invention.

### DETAILED DESCRIPTION

In a computer system, such as a database management system, transactions or operation requests, such as database queries, may arrive at the computer system dynamically. It will be appreciated that although some of the following discussion is directed to queries of databases, the methods and systems described herein may be applied to tasks or jobs in other forms of queue-based systems, such as computer operating systems. There may be a range of values of MPL that may successfully be executed by the computer system. For any given set of operations, referred to as a workload, there may be a relatively small range of values of MPL that will provide close to optimum usage of the computer system. Throughput or completion of the operations is an example of a metric that may be used to gauge the operation of the computer system. A given metric may have a minimum or maximum in a range of acceptable MPLs. As an example, for a set of similar queries that may arrive at a database system dynamically, there may a small range of values for the MPL that yield optimal or close to optimal response time and throughput. Such a response function may be treated as a unimodal function.

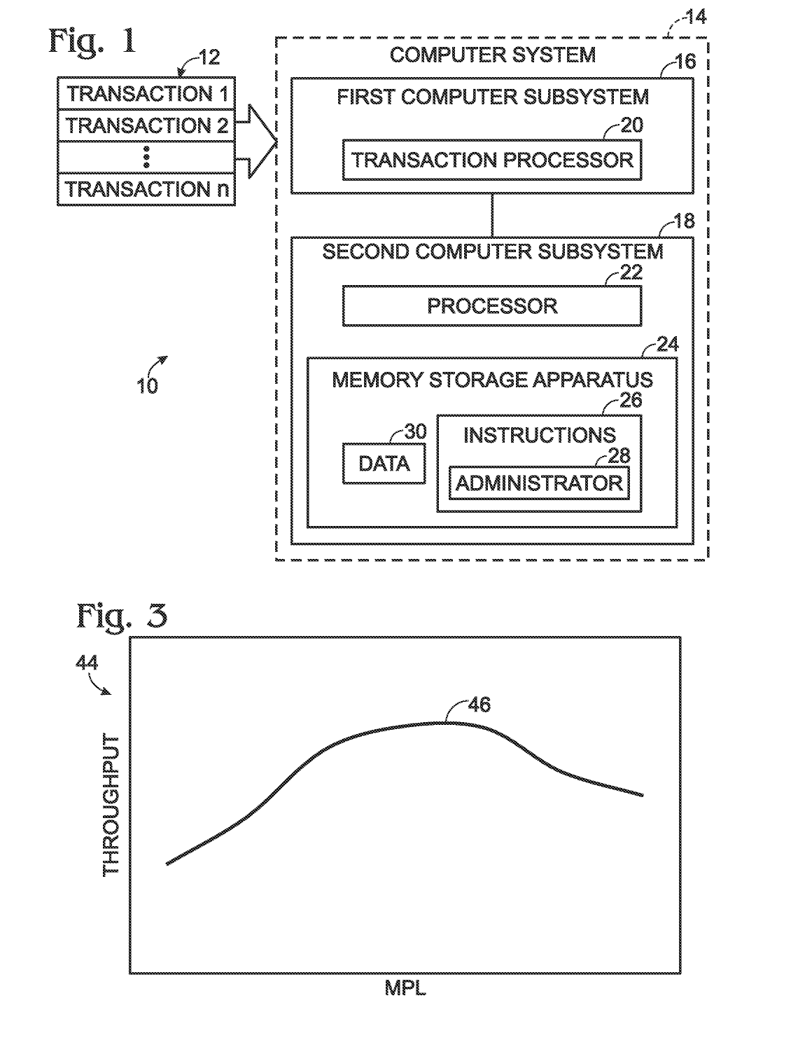

FIG. 1 illustrates an example of a data processing system 10 that may perform scheduled computer operations, which may dynamically arrive from another source, such as a user's computer system or network. As an example, a set 12 of n transactions are shown in a queue prior to being input into the data-processing system for execution. Data processing system 10 may include one or a plurality of associated computer systems. In this example, there is shown a single computer system 14.

Whether there are one or more computer systems, data-processing system 10 may include a first computer subsystem 16 and a second computer subsystem 18. In this example, first computer subsystem 16 may perform the operations from set 12 that may be assigned to it by computer subsystem 18. Computer subsystems 16 and 18 may be in communication with each other, either as parts of a single computer system 14, or as parts of separate computer systems. Accordingly, computer subsystems 16 and 18 may each or in combination include intercommunication devices such local and wide area networks, as well as hardware and software, firmware, or a combination of these. For example, hardware for computer subsystem 16 may include a central processing unit (CPU) or processor 20, as well as a memory storage apparatus, such as a database, and input/output connections, chipsets, and other hardware components, not shown.

The memory storage apparatus may be any suitable type of storage device or devices resident in or in association with one or more of the computer systems, and may include non-volatile memory and volatile memory. The non-volatile memory may include executable software instructions for execution by the processor, including instructions for an operating system and other applications, such as instructions for database processing, as well as storing data, such as a database on which the operations are performed.

Similarly, hardware for computer subsystem 18 may include a central processing unit (CPU) or processor 22, as well as a memory storage apparatus 24, and input/output connections, chipsets, and other hardware components, not specifically shown. Processors 20 and 22 may be independent processors, portions of co-processors, or functionally part of a single processor. Memory storage apparatus 24 may be any suitable type of storage device or devices resident in or in association with computer systems 14, and may be part of a shared storage apparatus with the memory storage apparatus serving computer subsystem 16. Storage apparatus thus may include non-volatile memory and volatile memory. The non-volatile memory may include executable software instructions 26 for execution by the processor, including instructions for an operating system and other applications, such as instructions for an administrator 28 that may determine an MPL for computer subsystem 16, as well as storing data 30.

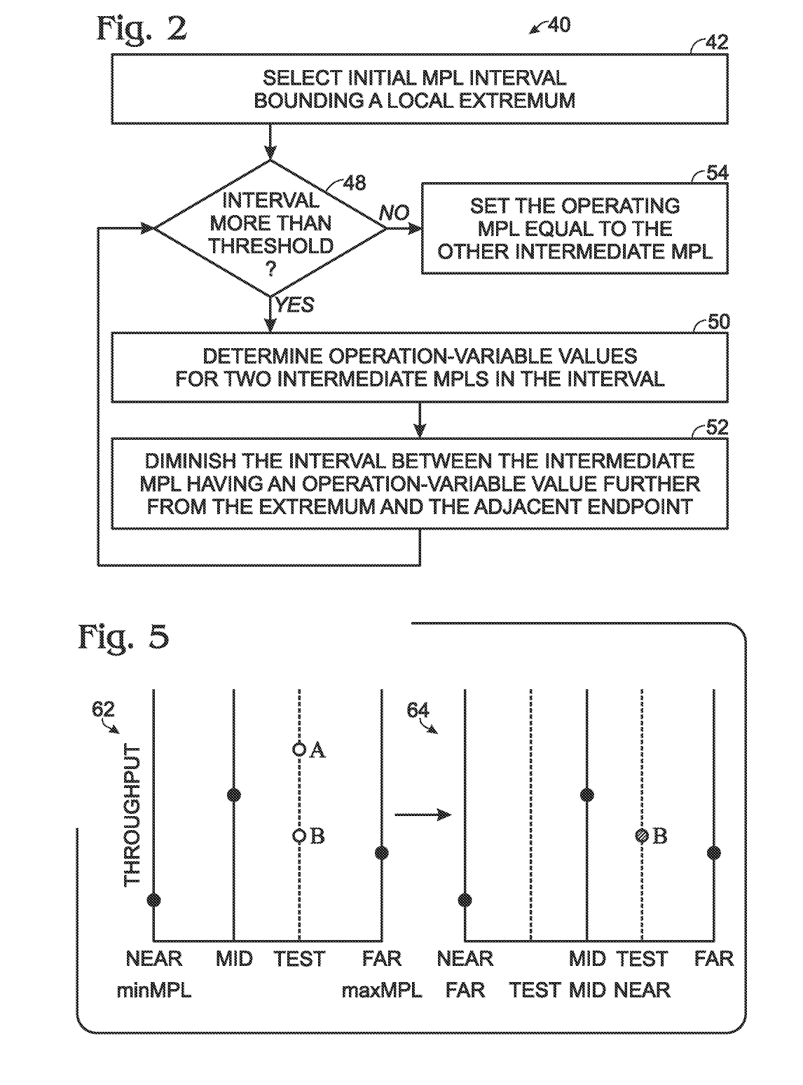

An example of a method 40 for determining a multiprogramming level (MPL) for first computer subsystem 16 is illustrated in the flow chart of FIG. 2. Such a method may be implemented on second computer subsystem 18. The method may include in a step 42 selecting an initial MPL interval having endpoints that bound a local extremum of a computer-system operation variable that is a unimodal function of the MPL.

FIG. 3 is a graph 44 illustrating an example of a unimodal function represented by a curve 46. MPL values increase from left to right on the horizontal axis, and throughput values increase from bottom to top on the vertical axis. Curve 46 shows that as the MPL increases from the left, the throughput initially increases as well. In a central region of the MPL in this example, the throughput reaches a maximum. To the right of the maximum, the throughput decreases for increasing values of MPL. It should be noted that curve 46 may not be known for a given workload running on a given computer system, so a way of finding an MPL on the curve near the maximum may provide an MPL that produces a good MPL. Such a curve may apply to a given set of operations or operations of a given type, such as throughput. If the characteristics or makeup of the operations change, the curve may not apply and new calculations may be required to find positions on the new curve.

It will be appreciated that the function illustrated in FIG. 3 has a maximum. A different function may have a minimum. A unimodal function may have either a local maximum or a local minimum in a range of interest. In general terms, then, a unimodal function may be considered to have an extremum in a range of interest.

As applied to databases, the MPL may be the number of queries (or, more generally, pieces of work or operations) that are permitted to execute concurrently in a system. As MPL increases from one, the more queries execute, the better they can share and fully use the resources and so throughput goes up. This corresponds to the left side of curve 46. At some point, however, the resources become saturated and so throughput remains stable with increasing MPL, as indicated at the center of the curve. Finally, the queries create so much contention for resources that the overhead for sharing the resources, e.g. the context switching overhead for the CPU or the contention for space for pages in the buffer pool, dominates and the throughput decreases with high MPL, as indicated by the right side of the curve.

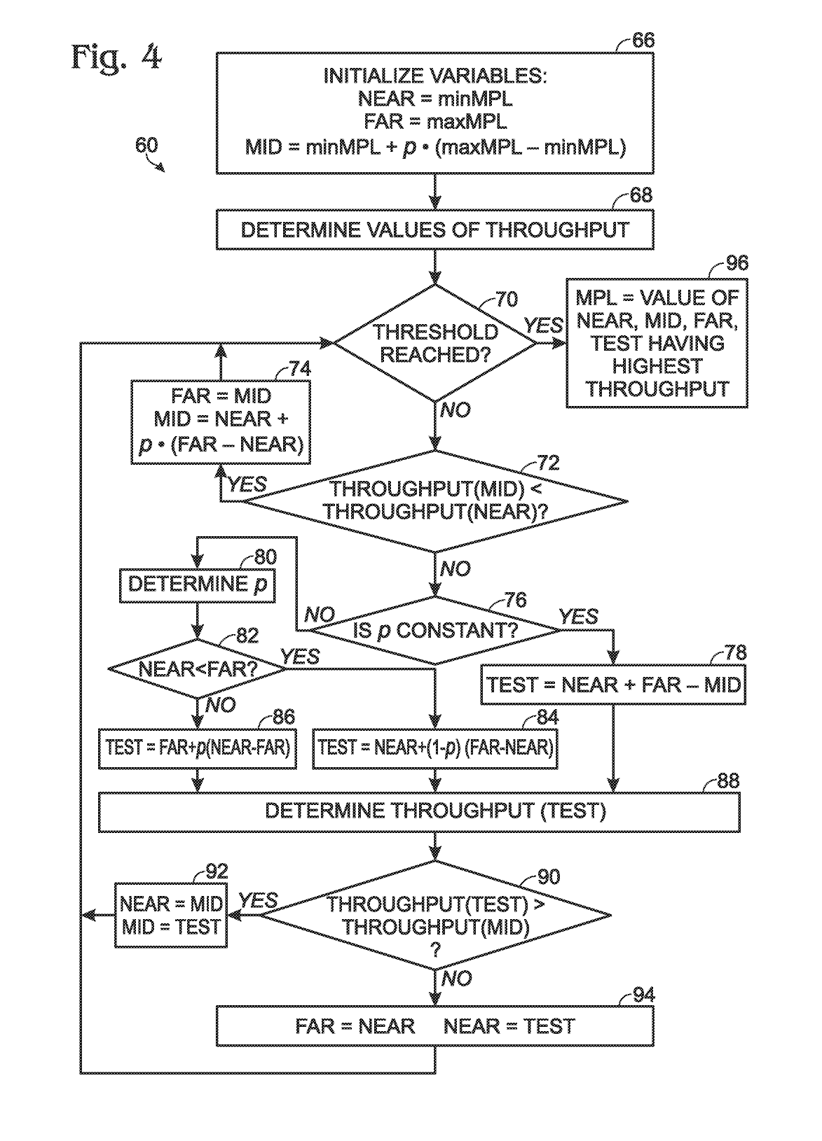

Referring again to FIG. 2, a determination may be made at step 48 as to whether the MPL interval under consideration has a length more than a threshold. If it is more than a threshold, operation-variable values may be determined at step 50 for two intermediate MPLs in the interval. As will be discussed with reference to the more detailed flow chart of FIG. 4, these operation-variable values may be determined in successive iterations, rather than in a single step.

Knowing the operation-variable values, the interval may be diminished in step 52 by the section of the interval between the one of the intermediate MPLs having an operation-variable value further from the extremum (optimum, maximum, or minimum), and the interval endpoint adjacent to the one intermediate MPL. Steps 50 and 52 may then be repeated for this reduced-length interval unless the interval is not more than the threshold. If the interval is not more than the threshold, as determined in step 48, then the operating MPL is set at a step 54 to be equal to an MPL in the current interval, such as the known MPL having the highest throughput or simply the other intermediate MPL.

FIG. 4 illustrates an example of a method 60 for finding an MPL, and is discussed with reference to simplified graphs 62 and 64 illustrated in FIG. 5. In particular, the method illustrated in FIG. 4 may use a modified version of Golden section search or a Fibonacci search on a computer-system operation variable that is a unimodal function of MPL, such as is illustrated in FIG. 3, to find a good MPL. This may be done without prior knowledge of either the operations, such as queries, or the computer subsystem architecture or software.

In a step 66, first two values, shown as minMPL and maxMPL, are chosen that bound the range of MPL values to be considered. If MPL is expressed as a real number, then minMPL and maxMPL may be appropriate real numbers. If MPL is expressed as integers, then minMPL and maxMPL may be integers. In the description below, Fibonacci numbers may be used where the MPL is expressed as integers. A Fibonacci number is a number that is equal to the sum of the two preceding Fibonacci numbers, i.e., Fₙ=Fₙ₋₁+Fₙ₋₂, for n>1, with F₀=0 and F₁=1. Thus, 0, 1, 1, 2, 3, 5, 8, 13, 21, 34, 55, . . . are successive Fibonacci numbers.

An initial interval is the range between the initial endpoints, and may be defined as (maxMPL−minMPL). In the situation where MPLs are integers, then the interval (maxMPL−minMPL) may be restricted to the set of Fibonacci numbers. For example, if maxMPL=2590 and minMPL=6, the interval (maxMPL−minMPL)=2584, a Fibonacci number.

Variables used in the illustrated method may include NEAR, FAR, MID, and TEST. As a starting point, first interval endpoint variable FAR is set equal to maxMPL and second interval endpoint variable NEAR is set equal to minMPL, resulting in an initial interval defined as (FAR−NEAR). An initial intermediate point in the interval is determined by the equation: MID=minMPL+ρ·(maxMPL−minMPL), where ρ is a factor between 0 and ½. This puts MID closer to NEAR than to FAR. The factor ρ may be fixed or it may be variable. A useful factor where MPL is a real number is 1/(g+1), where g is the golden ratio, and is approximately equal to 1.618. The factor ρ, then is approximately 0.382. The lengths of the sub intervals (FAR−MID) and (MID−NEAR) may thereby be golden sections, as may be the interval (FAR−NEAR) and (FAR−MID). A factor ρ my be used that is between ½ and 1, with appropriate adjustments to computations as discussed below.

In step 68, the throughput of the initial variables may be determined. The black dots on the vertical lines above these variables indicate relative examples of what these values may be determined to be. It is seen in this example that the throughput of NEAR is less than the throughput for FAR, and the throughput for MID is more than the throughput of FAR.

As a further example for a search using Fibonacci intervals, an initial interval that corresponds in length to a Fibonacci number may be selected. A variable LowBound may be set to be the smallest MPL level for which an actual throughput test may be performed. LowBound may also be set to an artificially low value of MPL, even a negative number, for which the throughput may be set equal to zero. A variable HighBound may be set to be the largest MPL level for which an actual throughput test may be performed. An MPL level in the interval [LowBound−HighBound] at which the throughput is known to be positive, referred to as Sample, is selected, with throughput being unimodal in the interval. A ThroughPut function that is used to determine throughput levels for values of MPL may be defined to return zero for values outside of the range [LowBound−HighBound].

A Fibonacci number, Fₙ₋₂, may then be selected such that Fₙ₋₂>max(Sample−LowBound, HighBound−Sample). Any such Fibonacci number may be used; but, in practice, Fₙ₋₂ may be selected such that it is the smallest Fibonacci number that satisfies the condition. Variable values for the search may then be set, as in step 66, as follows:

NEAR=Sample−Fₙ₋₂

MID=Sample

FAR=Sample+Fₙ₋₁

This produces the result in step 68 that NEAR<LowBound, so ThroughPut(NEAR)=0, and FAR>HighBound, so ThroughPut(FAR)=0. Also, ThroughPut(MID)=ThroughPut(Sample)>0. Also, the initial interval (FAR−NEAR)=Fₙ.

Chart 62 of FIG. 5 illustrates visually an example of this initialization of variables. The bounds of MPL under consideration are shown as minMPL and maxMPL. Corresponding general initial positions of NEAR, MID, and FAR are shown just above minMPL and maxMPL as determined in step 66.

A determination may be made at step 70 as to whether the current interval, in this instance, the initial interval, is less than a threshold. If it is not, then a determination may be made at a step 72 as to whether the throughput of MID is less than the throughput of NEAR. If it is, then the extremum must exist between MID and NEAR and the interval may be diminished by the portion of the interval between FAR and MID. Accordingly, in step 74, FAR is set equal to MID and MID=NEAR+ρ·(FAR−NEAR). This may define a new MID that is between NEAR and MID, and is not shown in chart 62. Processing then returns to step 70.

If the throughput of MID is not less than the throughput of NEAR, then a second midpoint referred to as TEST must be determined. The value of TEST may be based on the value of ρ. If ρ is a constant, as determined at step 76, then in step 78, the value of TEST may be determined by the equation TEST=NEAR+FAR−MID.

If ρ is not a constant, then it may be determined in step 80. In the case of integer MPL values and when using intervals restricted to Fibonacci numbers, the factor ρ=1−(Fₙ₋ₖ₋₁)/(Fₙ₋ₖ) for the k^{th} interval, with k=1 for the initial interval. The value of n may be determined by the inequality Fₙ>(maxMPL−minMPL)/ε, where n is the smallest integer for which the inequality is true and c is the threshold or tolerance level. With Fibonacci numbers, the ratio (Fₙ₋ₖ₋₁)/(Fₙ₋ₖ) is generally equal to about 0.618 except for small values of n, so the factor ρ is about 0.382.

Once ρ is determined, TEST may be determined. TEST may be a second midpoint between NEAR and FAR that will be considered. If NEAR is less than FAR, as determined in step 82, then in step 84 TEST may be determined by the equation TEST=NEAR+(1−ρ)(FAR−NEAR). This may correspond to the situation shown in chart 62. If on the other hand FAR is less than NEAR, then TEST may be determined in step 86 by the equation TEST=FAR+ρ(NEAR−FAR). The dashed vertical line in chart 62 represents the new position of TEST.

After determining TEST in step 78, 84 or 86, the throughput at TEST may be determined in a step 88. The value of throughput at TEST may then be compared in step 90 to the value of throughput at MID. If the THROUGHPUT(TEST) is greater than THROUGHPUT(MID), then MID may become a new NEAR and TEST may become a new MID, as provided in step 92. This is because the highest known throughput value lies between MID and FAR. This corresponds with the situation in which the throughput of TEST is indicated by circle A in chart 62. As a result, the interval may be reduced or diminished by the section of the interval between NEAR and MID. Processing then may be repeated beginning with step 70.

On the other hand, if the THROUGHPUT(TEST) is less than THROUGHPUT(MID), as indicated by circle B in chart 62, then the highest known throughput is at MID, between NEAR and TEST. The interval may be diminished by the section of the interval between TEST and FAR. This is provided in step 94 in which a new FAR is set equal to NEAR and a new NEAR is set equal to TEST.

This transition to a reduced-length interval is illustrated in chart 64. The process may then be repeated beginning with step 70, in which yet a new TEST is determined that is between the new MID and the new FAR, as represented by the left dashed vertical line in the chart.

In another example of a process of computing a new TEST when intervals are restricted to Fibonacci numbers, the intervals may be decremented by successively smaller Fibonacci numbers rather than computing a ratio. For example, if FAR−NEAR=Fₙ₋ₖ, Then a MID is selected such that FAR−MID=Fₙ₋ₖ₋₁. A TEST may then be selected such that FAR−TEST=Fₙ₋ₖ₋₂.

When it is determined in step 70 that the interval length has reached the selected threshold, then the MPL for the database system may be set in step 96 equal to one of the values of NEAR, MID, FAR or TEST, such as the one having the highest throughput. This completes the selection process for the current workload. In another example, MPL may be set to the lowest value of these variables for which the throughput is within a factor c of the highest throughput. Using a lower MPL may leave more resources free for other work.

In summary, the methods and apparatus described above generally may provide for selecting a triple of three points (NEAR, MID, and FAR), not necessarily equally spaced, where the performance at the middle point may be better than the performance at either end. A new interior point, TEST, may be determined and the performance at the new point may be evaluated. If the performance at the new point is better than the performance at the old middle MID, it can become the new middle of a denser triple. If the performance at the new point TEST is not as good as the performance at the old middle MID, then the new point may become one end of a denser triple.

This process may repeat for successively smaller intervals as the search converges to a smaller interval until the throughput improvement is low enough with successive iterations that an interval limit (threshold) or other limit is reached. Whenever the query mix changes or measured throughput diverges significantly from previous measured values, the search may be repeated.

The method disclosed may be embodied in a data processing system 10 to find and set an MPL automatically, without requiring a person to set it. It may be performed without requiring any knowledge or model of the system hardware or software. The same algorithm may work for a system that uses an MPL setting to control scheduling of work. The value of the MPL may be changed dynamically as the mix of work changes or as system resource availability changes, for example due to maintenance tasks running.

We claim:

1. A method of determining a multiprogramming level (MPL) for a first computer subsystem, implemented on a second computer subsystem, the method comprising:
selecting an initial MPL interval having endpoints that bound a local extremum of a computer-system operation variable that is a unimodal function of the MPL;
for each interval having a length more than a threshold,
determining operation-variable values for two intermediate MPLs in the interval; and
diminishing the interval by the section of the interval between the one of the intermediate MPLs having an operation-variable value further from the extremum, and the interval endpoint adjacent to the one intermediate MPL; and
setting the operating MPL equal to the MPL of an intermediate MPL or interval-endpoint MPL when the interval has a length that is not more than the threshold.

2. The method of claim 1, further comprising, prior to determining operation-variable values, selecting each intermediate MPL at a location in the interval that is a distance from an endpoint of the interval that is a predefined relationship to the length of the interval.

3. The method of claim 2, wherein the selecting each intermediate MPL at a location includes using in a current interval an intermediate MPL selected for the previous interval that was diminished to produce the current interval, and selecting a second intermediate MPL at a location in the current interval that is a distance from an endpoint of the current interval that is a predefined relationship to the length of the current interval.

4. The method of claim 2, wherein selecting each intermediate MPL at a location includes selecting each intermediate MPL at a location in the interval that is a distance from an endpoint of the interval that is a fraction of the length of the interval.

5. The method of claim 4, wherein selecting each intermediate MPL at a location includes selecting each intermediate MPL at a location in the interval that is a distance from an endpoint of the interval that is a fraction of the length of the interval that is the same for all intervals.

6. The method of claim 5, wherein selecting each intermediate MPL at a location includes selecting each intermediate MPL at a location in the interval that is a distance from an endpoint of the interval that is a fraction of the length of the interval that is based on the golden ratio.

7. The method of claim 2, wherein diminishing the interval includes diminishing the interval by a length appropriate to produce a diminished interval having a length equal to a Fibonacci number.

8. The method of claim 7, wherein diminishing the interval includes diminishing an interval having a length equal to a first Fibonacci number by a length appropriate to produce a diminished interval having a length equal to a second Fibonacci number that is the sequentially next Fibonacci number lower than the first Fibonacci number.

9. The method of claim 1, wherein setting the operating MPL includes setting the operating MPL to the one of the intermediate MPL and interval-endpoint MPLs having a value closest to the local extremum of the computer-system operation variable.

10. A first computer subsystem for determining a multiprogramming level (MPL) for a second computer subsystem, comprising:
memory storage apparatus for storing data and processor-readable instructions; and
a processor for executing the processor-readable instructions for: selecting an initial MPL interval having endpoints that bound a local extremum of a computer-system operation variable that is a unimodal function of the MPL; for each interval having a length more than a threshold,
determining operation-variable values for two intermediate MPLs in the interval; and
diminishing the interval by the section of the interval between the one of the intermediate MPLs having an operation-variable value further from the extremum, and the interval endpoint adjacent to the one intermediate MPL; and
setting the operating MPL equal to the other intermediate MPL when the interval has a length that is not more than the threshold.

11. The data processing system of claim 10, wherein the processor is further for executing the processor-readable instructions for, prior to determining operation-variable values, selecting each intermediate MPL at a location in the interval that is a distance from an endpoint of the interval that is a predefined relationship to the length of the interval.

12. The data processing system of claim 11, wherein the processor is further for executing the processor-readable instructions for using in a current interval an intermediate MPL selected for the previous interval that was diminished to produce the current interval, and selecting a second intermediate MPL at a location in the current interval that is a distance from an endpoint of the current interval that is a predefined relationship to the length of the current interval.

13. The data processing system of claim 11, wherein the processor is further for executing the processor-readable instructions for selecting each intermediate MPL at a location in the interval that is a distance from an endpoint of the interval that is a fraction of the length of the interval.

14. The data processing system of claim 11, wherein the processor is further for executing the processor-readable instructions for diminishing the interval by a length appropriate to produce a diminished interval having a length equal to a Fibonacci number.

15. The data processing system of claim 10, wherein the processor is further for executing the processor-readable instructions for setting the operating MPL to the one of the intermediate MPL and interval-endpoint MPLs having a value closest to the local extremum of the computer-system operation variable.

16. A computer-readable storage device readable by one or more computer systems and having embodied therein a program of computer-readable instructions that, when executed by the one or more computer systems, provide for:
selecting an initial MPL interval having endpoints that bound a local extremum of a computer-system operation variable that is a unimodal function of the MPL;
for each interval having a length more than a threshold,
determining operation-variable values for two intermediate MPLs in the interval; and
diminishing the interval by the section of the interval between the one of the intermediate MPLs having an operation-variable value further from the extremum, and the interval endpoint adjacent to the one intermediate MPL; and
setting the operating MPL equal to the MPL of an intermediate MPL or interval-endpoint MPL when the interval has a length that is not more than the threshold.

17. The computer-readable storage device of claim 15, wherein the program further provides for selecting each intermediate MPL at a location in the interval that is a distance from an endpoint of the interval that is a predefined relationship to the length of the interval.

18. The computer-readable storage device of claim 17, wherein the program further provides for the selecting each intermediate MPL at a location includes using in a current interval an intermediate MPL selected for the previous interval that was diminished to produce the current interval, and selecting a second intermediate MPL at a location in the current interval that is a distance from an endpoint of the current interval that is a predefined relationship to the length of the current interval.

19. The computer-readable storage device of claim 17, wherein the program further provides for selecting each intermediate MPL at a location in the interval that is a distance from an endpoint of the interval that is a fraction of the length of the interval.

20. The computer-readable storage device of claim 17, wherein the program further provides for diminishing the interval by a length appropriate to produce a diminished interval having a length equal to a Fibonacci number.
